(19) United States
(12) Patent Application Publication
(10) Pub. No.: US 2018/0157557 A1
(43) Pub. Date: Jun. 7, 2018

(54) DETERMINING REBOOT TIME AFTER SYSTEM UPDATE

(71) Applicant: INTEL CORPORATION, Santa Clara, CA (US)

(72) Inventors: Ismo PUUSTINEN, Helsinki (FI); Jaska UIMONEN, Helsinki (FI)

(73) Assignee: INTEL CORPORATION, Santa Clara, CA (US)

(21) Appl. No.: 15/368,327

(22) Filed: Dec. 2, 2016

(51) Int. Cl. G06F 11/14; G06F 9/44; G06F 9/445

(52) U.S. Cl. CPC G06F 11/1438; G06F 2201/805; G06F 8/65; G06F 9/4406

(57) ABSTRACT

The present disclosure provides a reboot time after a system update. Providing a reboot time after a system update can include processing a request to reboot the UE, accessing the state data representing the state of the service running on the UE, and generating a service activity level for the service from the state data. Providing a reboot time after a system update can also include comparing the service activity level to an update criticality level, rescheduling a determination of whether to reboot the UE if the update criticality level is less than the service activity level, and rebooting the UE if the service activity level is less than the update criticality level.

### TECHNICAL FIELD

The present disclosure relates to determining a reboot time after a system update. In particular, the present disclosure relates to determining a reboot time after system update based on a state of a plurality of services.

### BACKGROUND

A computing device may be rebooted after a software update is performed on a computing device. In some examples, the computing device may have to be rebooted for the software update to take effect. The software update can be performed on a remote computing device.

The system update may be installed to two locations, which are identical in the beginning. A system may be booted from a first device. The system updates are then installed to a second device (e.g., second location). The system is rebooted into the second device. This allows the system to be rolled back by booting back to the first device. This mechanism allows system recovery in case of failure during the updates (e.g., power failure and broken package, among other failures).

### BRIEF DESCRIPTION OF THE DRAWINGS

FIG. 1 illustrates a system for determining a reboot time after a system update according to various embodiments.

FIGS. 2, 3, and 4 illustrate an example of determining a reboot time after a system update according to various embodiments.

FIG. 5 illustrates an example computing device suitable for use to practice aspects of the present disclosure, according to various embodiments.

FIG. 6 illustrates a storage medium having instructions for practicing methods described with references to FIGS. 2-4, according to various embodiments.

### DETAILED DESCRIPTION OF PREFERRED EMBODIMENTS

Wireless mobile communication technology uses various standards and protocols to generate and/or transmit data between a base station and a wireless communication device. Wireless communication system standards and protocols can include, for example, 3rd Generation Partnership Project (3GPP) long term evolution (LTE); the Institute of Electrical and Electronics Engineers (IEEE) 802.16 standard, which is commonly known to industry groups as worldwide interoperability for microwave access (WiMAX); and the IEEE 802.11 standard, which is commonly known to industry groups as Wireless Local Area Network (WLAN) or Wi-Fi. In 3GPP radio access networks (RANs) in LTE systems, a base station may include Evolved Universal Terrestrial Radio Access Network (E-UTRAN) Node B (also commonly denoted as evolved Node B, enhanced Node B, eNodeB, or eNB) and/or Radio Network Controllers (RNCs) in the E-UTRAN, which communicate with a wireless communication device, known as user equipment (UE). In LTE networks, the E-UTRAN may include a plurality of eNodeBs and may communicate with the plurality of UEs. LTE networks include a radio access technology (RAT) and core radio network architecture that can provide high data rates, low latency, packet optimization, and improved system capacity and coverage.

A problem in performing a system update is determining when to reboot a system on which the update was performed. In some examples, the system can be rebooted as soon as possible after the system is updated. The reboot of the system can be delayed (e.g., snooze) by a user until the system forces a reboot of the system. Some systems may reboot immediately after the system is updated. Some systems may perform system updates if a user is shutting down or rebooting the system.

However, the problem is more acute on internet of things (IoT) systems (e.g., IoT UE), which may not have an active user using the IoT system at all times. Some systems may perform a system update and an associated reboot during off use periods (e.g., night) to cause the least inconvenience.

As used herein, a UE device can comprise a wireless communication device and/or a device that may be active without user control. That is, a UE device can include an IoT UE, a UE, and/or a device that may not be configured to perform wireless communication and that functions without user supervision for any period of time.

Some systems may inhibit shutdown/reboot when the system is performing critical operations. However, inhibiting shutdown/reboot when the system is performing critical operations only functions if services are aware of the environment they are running in and support shut down inhibition.

In some embodiments, a reboot can be initiated based on a state of a number of services associated with the system. The state of the services can be determined based on a plurality of properties associated with the services. The plurality of properties can include the system resources consumed by the services.

Apparatuses, methods and storage media associated with generating random number generator (RNG) states are disclosed herein. In embodiments, an apparatus for computing may include one or more processors, with each processor having one or more processor cores; one or more wireless communication components; memory coupled with the one or more processors to host a plurality of virtual machines operated by the one or more processors; and a virtual machine monitor to be loaded into the memory and operated by the one or more processors to manage operation and resource allocation to the virtual machines.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an application specific integrated circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

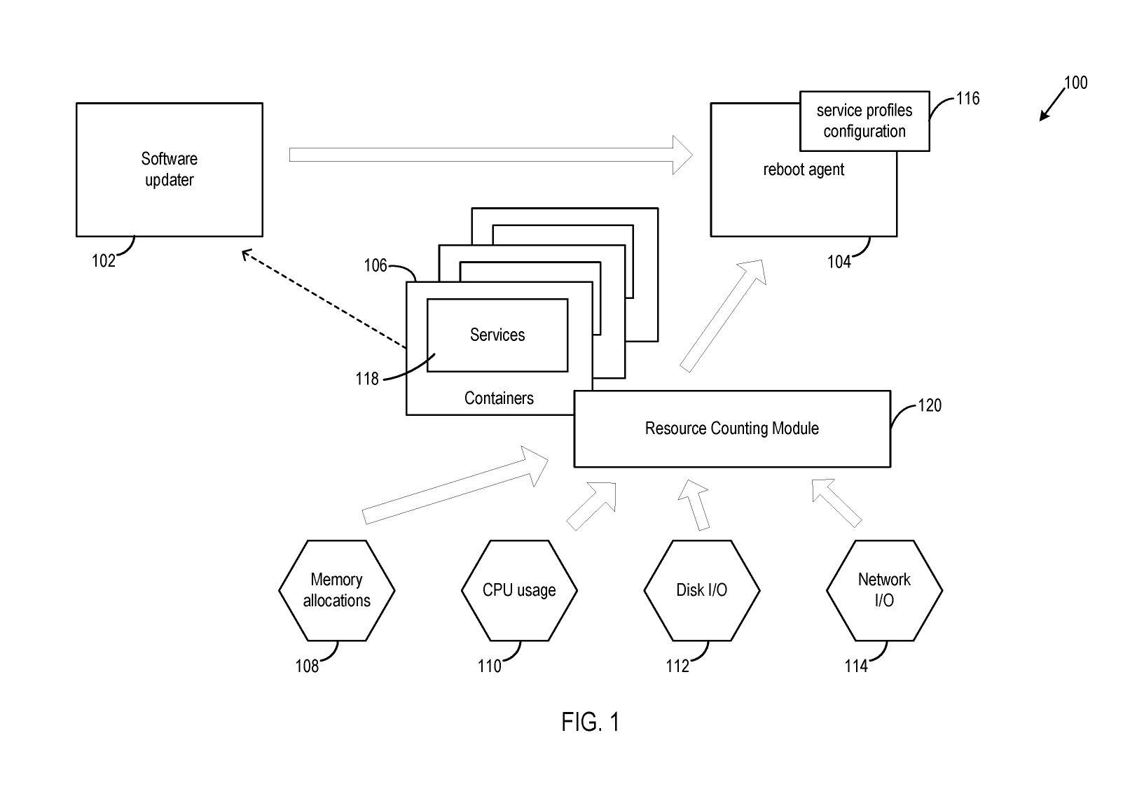

FIG. 1 illustrates a system 100 for determining a reboot time after a system update according to various embodiments. System 100 includes a software updater 102, a reboot agent 104, containers 106, services 118, and a resource counting module 120.

The system 100 can consist of a device and/or a number of devices coupled together via a network. For example, each of the components (e.g., the software updater 102, the reboot agent 104, the containers 106, the services 118 and/or the resource counting module 120) of system 100 can be implemented in one or more devices. The devices can be coupled via a local network and/or a global network. In some examples, the system 100 can be a UE and/or an IoT UE.

The software updater 102 can perform an update of the system 100. An update (e.g., system update) can comprise replacing and/or adding computer readable instructions to the services 118, the containers 106, an operation system (OS) associated with system 100, and/or firmware associated with a computing device hosting the system 100, among computer readable instructions that can be updated. For example, an update can comprise an update to a driver. The software updater 102 can comprise hardware and/or software.

The software updater 102 can perform an update before the system 100 is rebooted and/or after the system 100 is rebooted. The software updater 102 can also perform the update before a reboot is initiated, after a reboot is initiated but before the reboot is performed, and/or after the reboot is performed. As used herein, rebooting a system 100 can include shutting down, restarting, and/or disrupting the operation of the system 100.

In FIG. 1 the reboot agent 104 can be independent of the software updater 102. In some embodiments, the reboot agent 104 can be incorporated into the software updater 102.

The reboot agent 104 can initiate and/or perform a reboot of the system 100. The reboot agent 104 can also determine when to initiate and/or perform the reboot of the system 100. The reboot agent 104 can determine when to initiate and/or perform a reboot of the system 100 based on the state of the containers 106 and/or the services 118.

The containers 106 can include one or more services 118. The containers 106 are software and/or hardware that can implement a class and/or a data structure that can be used to implement the services 118. The container 106 provides access to the services 118 and/or data associated with the services 118. Each of the containers 106 can comprise one or more of the services 118. As used herein the containers 106 represent a group of technologies that can be used to monitor and/or modify the state of software running on system 100.

As used herein, a service can include software and/or hardware configured to perform a function. For example, the services 118 can determine, log, and/or report a temperature via a network of the system 100; the services 118 can control a camera to generate images, store images, and/or report images via a network; the services 118 can receive data from other IoT devices, store data, and/or transmit data via a network, among other functions that the services 118 can perform.

The services 118 can consume a plurality of resources to perform the service functions. For example, the services 118 can access and/or utilize memory resources, central processing unit (CPU) resources, and disk resources, among other types of resources available to the services 118. Memory resources can include memory allocations 108. CPU resources can include CPU usage 110. Disk resources can include disk input/output (I/O) 112. Network resources can include network I/O 114. The memory allocations 108, the CPU usage 110, the disk I/O 112, and/or the network I/O 114 can be measured using a variety of metrics. For example, CPU usage 110 can be measured in a percentage of CPU resources utilized and/or as quantities of computations performed over a period of time (e.g., time duration).

The plurality of resources consumed by each of the services 118 can be defined by the resource counting module 120. The resource counting module 120 can count the memory allocations 108 performed by each of the services 118 over a time period. The resource counting module 120 can determine a CPU usage 110 of each of the services 118. The resource counting module 120 can determine a disk I/O 112 of the services 118. The service counting module 120 can determine a network I/O 114 of the services 118. The resource counting module 120 can report the consumed resources and their associated counts to the reboot agent 104.

At a reboot agent 104, a state of the services 118 can be measured to determine a service activity level based on the resources utilized by the services 118. A service activity level can be an integer, a real number, a percentage, and/or a score, among types of values that the service activity level can take. A service activity level can define an activity level of a service from the services 118. The service activity level can be determined based on the memory allocations 108, the CPU usage 110, the disk I/O 112, and/or the network I/O 114. That is, the service activity level for each of the services 118 and/or for all of the services 118 can be determined based on the reported consumed resources provided by the resource counting module 120.

The activity levels for the services 118 can have a bearing on the availability of the services 118 for rebooting. For example, the more active that a service is, the less available the service is for rebooting, and the less active that a service is, the more available the service is for rebooting.

A balance between an activity level of a service and the availability of the service for rebooting can be guided by a policy. The policy can be enforced by the reboot agent 104. The reboot agent 104 can make the determination of whether to reboot the system 100 or postpone the reboot of the system 100 based on the service activity level of the services 118.

The reboot agent 104 can determine whether an update criticality level of an update/reboot is greater or less than the service activity level. The update criticality level represents an urgency of the update/reboot of the system 100 (e.g., UE). The update criticality level can be compared to the service activity levels to determine whether the criticality of the update/reboot is greater than the activity of the services 118 of the system 100.

The comparison of the update criticality level to the service activity levels can be performed in iterations until the system 100 is rebooted. After a first iteration of the comparison, the update criticality level can be incremented at each subsequent iteration of the comparison.

The update criticality level can be compared to a single service from the services 118 and/or to the services 118. For example, if the update criticality level is compared to a single service, then it can be determined whether the update criticality level is less than the service activity level. If the update criticality level is less than the service activity level, then a determination of whether to reboot the system 100 can be rescheduled (e.g., postponed). If the service activity level is less than the update criticality level, then the system 100 can be rebooted.

If the update criticality level is compared to the plurality of services 118, then a policy can be employed to determine whether the update criticality level is greater than or less than the service activity levels. For example, a policy can dictate that if the criticality level is greater than a single one of the service activity levels, then the criticality level is greater than the service activity levels. A different policy can dictate that the criticality level has to be greater than all of the service activity levels for the criticality level to be greater than the service activity levels. Yet another policy can dictate that the criticality level has to be greater than a percentage of the service activity levels for the criticality level to be greater than the service activity levels. The examples used herein for a policy are exemplary and not limiting. It is to be understood that other policies than those described herein can be enacted in determining whether the update criticality level is greater than or less than the service activity level.

In some examples, the service profiles configuration 116 can is s description of the service configured to be compatible with the reboot agent. For example, the service profile configuration 116 can describe that a reboot is not to be performed if service X is writing to a disk. Writing, by service X, to a disk can be classified as a critical operation for the system to operate. In some examples, writing, by service Y, to disk can be aborted to reboot the system 1000. The service profile configuration 116 can describe rules for different services. The reboot agent 104 can analyze the rules and determines a time to boot.

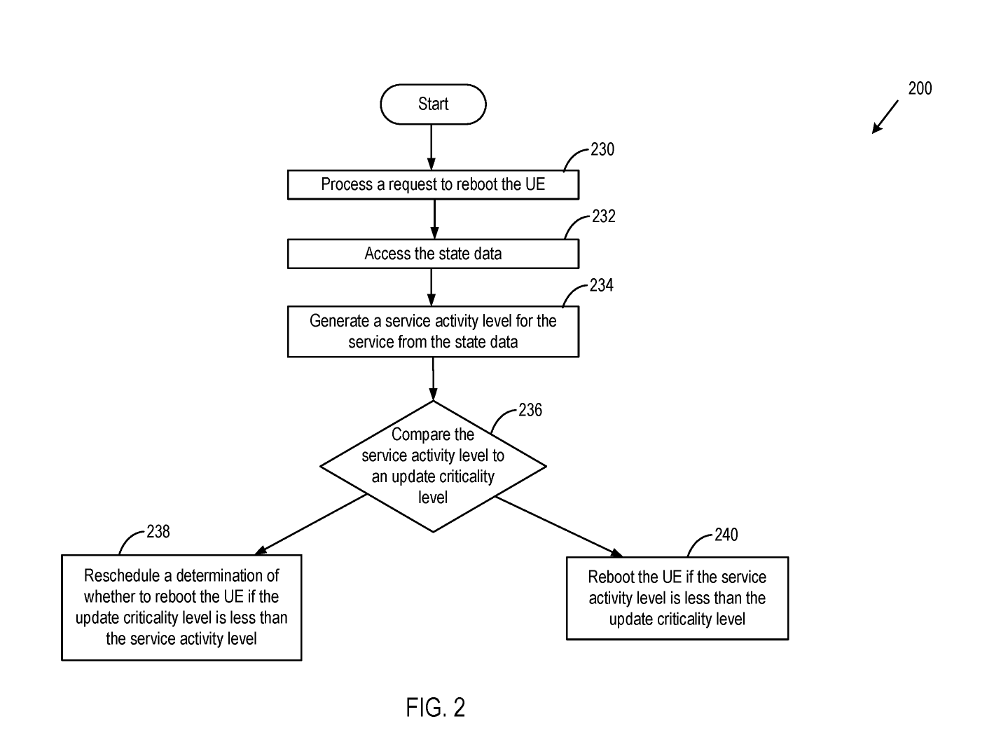

FIG. 2 illustrates an example of determining a reboot time after a system update according to various embodiments. The process 200 for determining a reboot time after a system update may include the operations of blocks 230-240. The operations may be performed by the reboot agent 104 of FIG. 1.

The process 200 may start at block 230. At block 230, the process 200 can process a request to reboot the UE. At block 232, the process 200 may access state data representing the state of the service running on the UE. At block 234, the process 200 can generate a service activity level for the service from the state data. At block 236, the process 200 can compare the service activity level to an update criticality level. At block 238, the process 200 can reschedule a determination of whether to reboot the UE if the update criticality level is less than the service activity level. At block 240, the process 200 can reboot the UE if the service activity level is less than the update criticality level.

Rescheduling the determination of whether to reboot the UE can include incrementing the update criticality level. Incrementing the update criticality level can correspond to classifying the reboot as more urgent than the update criticality level before the update criticality level is incremented.

In some examples, the update criticality level can be received from the software updater of the UE. The software updater can set the update criticality level based on a number of factors. For example, the software updater can set the update criticality level cased on a type of update, among other factors associated with setting the update criticality level. In some examples, the update criticality level can be set to a predefined value by the software updater and/or the reboot agent if the software updater does not set the update criticality level.

Generating the service activity level can include generating a score vector and generating the service activity level from the score vector. A score vector can represent a plurality of properties of a service. For example, if the service utilizes 10 megabytes (MBs)/s of memory allocations, 30% CPU usage, 5 MBs/s of disk I/O, and 7 MBs/s of network I/O, then a score vector can be [10, 30%, 5, 7]. The service activity level can be generated from the score vector [10, 30%, 5, 7].

Rescheduling the determination of whether to reboot the UE can further include rescheduling the determination of whether to reboot the UE after a predetermined amount of time. For example, if the reboot agent determines to reschedule the determination of whether to reboot the UE, then the determination of whether to reboot the UE can be rescheduled for a point in the future that is a predetermined amount of time into the future.

In some examples the state data can be collected by performing OS calls. OS calls can include, for example, executing software to determine the resources utilized by any one or all of the services. OS calls can include at least one of a cgroup call and a namespace call.

System (e.g., Linux system) resource usage can be tracked on a service level using cgroups. The Linux service management daemon can use cgroups to keep track of limit services including CPU, I/O, and memory subsystems. Using network name spaces, a containerization mechanism offered by systemd, it becomes possible to also track network use of a given system. The behavior of a system can be analyzed. The optimal moment for system reboot after an update can be decided based on the analysis.

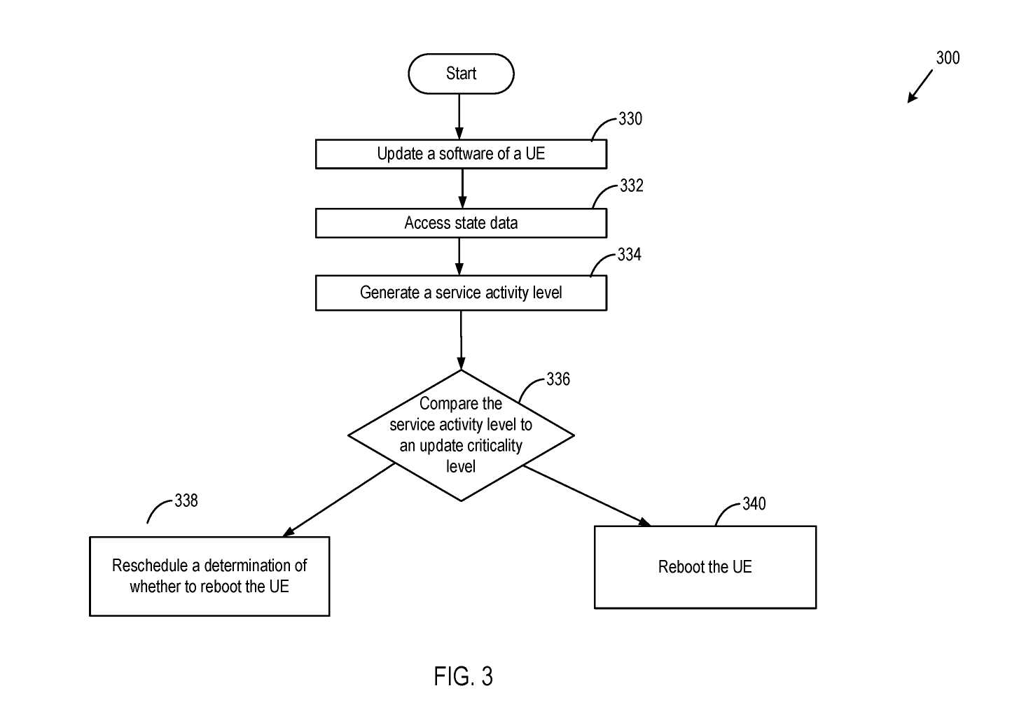

FIG. 3 illustrates an example of determining a reboot time after a system update according to various embodiments. The process 300 for determining a reboot time after a system update may include the operations of blocks 330-340. The operations may be performed by the software updater 102 of FIG. 1.

The process 300 may start at block 330. At block 330, the process 300 can update, via the software updater, a software of a UE. At block 332, the process 300 can access state data representing a state of a service running on the UE. At block 334, the process 300 can generate a service activity level for the service from the state data. At block 336, the process 300 can compare the service activity level to an update criticality level. At block 338, the process 300 can reschedule a determination of whether to reboot the UE if the update criticality level is less than the service activity level. At block 340, the process 300 can reboot the UE if the service activity level is less than the update criticality level.

As previously discussed, the state data can include at least one of network data, disk data, CPU data, and memory allocation data. The network data can comprise data describing network traffic associated with the service. The network data can identify whether the network traffic is interactive network traffic. Interactive network traffic can describe network traffic that is expected at a UE. For example, if a UE requests data from a base station, then the network traffic from the UE to the base station and the network traffic from the base station to the UE is network traffic because the UE can expect a response from the base station. In some examples, the network data can identify at least one of a quantity of network packets associated with the network traffic and a pattern associated with the network traffic.

Collecting the disk data can include collecting data describing an I/O load of the service. That is, the disk data can identify whether the service is writing data to a disk of the UE. For example, the disk data can determine whether the service is actively writing data to a disk to determine whether to reboot the UE. The disk data can also identify whether the service is receiving keystrokes from a keyboard. In some examples, the disk data can identify a time stamp of at least one of a last write operation and/or a received keystroke.

Collecting CPU data can include collecting data identifying a CPU load, of the UE, associated with the service. Collecting memory allocation data can further include collecting data associated with a memory allocation associated with the service.

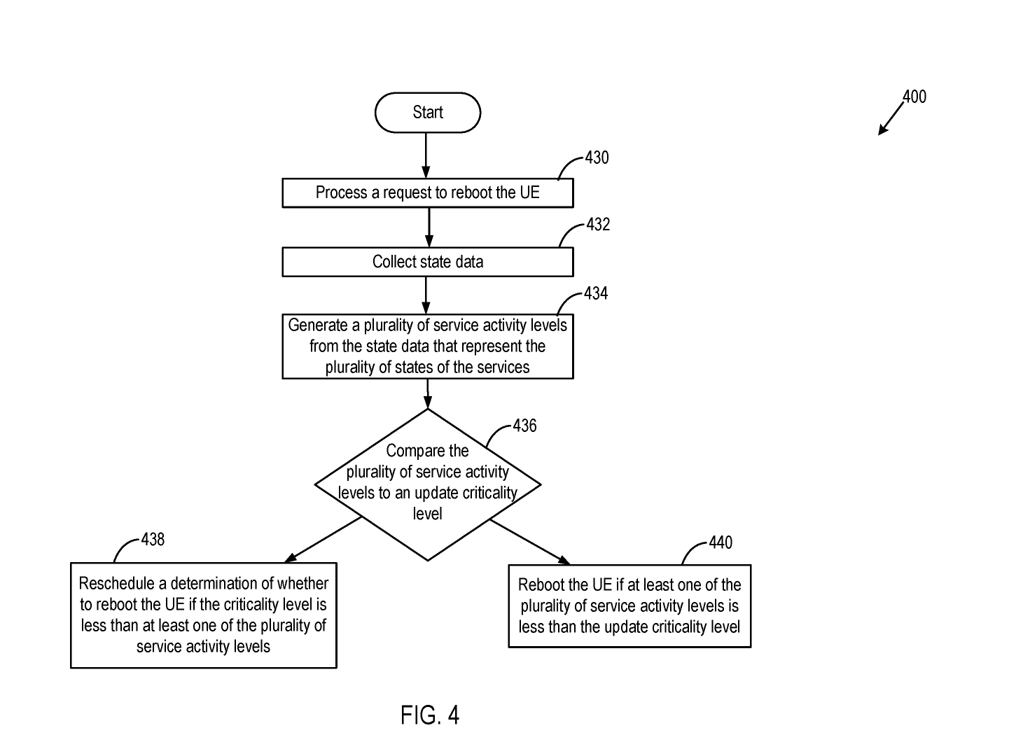

FIG. 4 illustrates an example of determining a reboot time after a system update according to various embodiments. The process 400 for determining a reboot time after a system update may include the operations of blocks 430-440. The operations may be performed by the reboot agent 104 of FIG. 1.

The process 400 may start at block 430. At block 430, the process 400 can process a request to reboot the UE. At block 432, the process 400 can collect state data representing a plurality of states of services running on the UE. At block 434, the process 400 can generate a plurality of service activity levels from the state data that represent the plurality of states of the services. At block 436, the process 400 can compare the plurality of service activity levels to an update criticality level. At block 438, the process 400 can reschedule a determination of whether to reboot the UE if the update criticality level is less than at least one of the plurality of service activity levels. At block 440, the process 400 can reboot the UE if at least one of the plurality of service activity levels is less than the update criticality level. The UE can be an IoT UE.

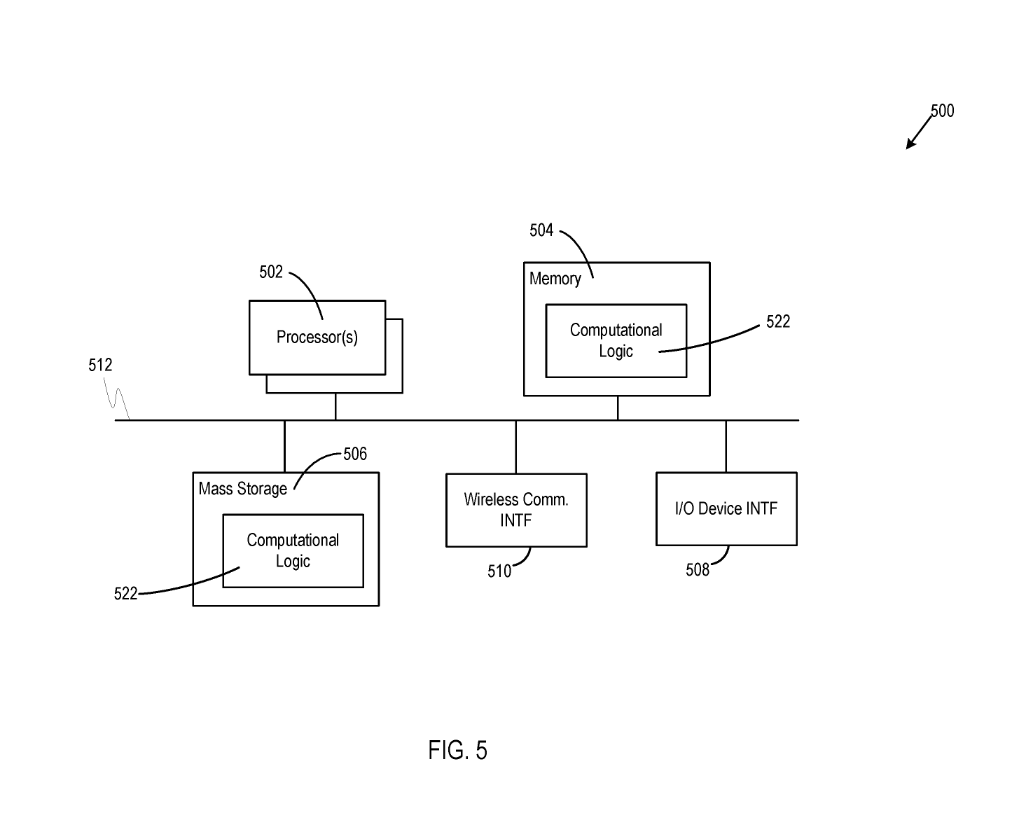

FIG. 5 illustrates an example computing device suitable for use to practice aspects of the present disclosure, according to various embodiments. As shown, computing device 500 may include one or more processors, each with one or more processor cores 502 and system memory 504. System memory 504 may be any volatile or non-volatile memory. Additionally, computing device 500 may include mass storage devices 506. Example of mass storage devices 506 may include, but are not limited to, tape drives, hard drives, compact disc read-only memory (CD-ROM) and so forth. Further, computing device 500 may include input/output devices 508 (such as display, keyboard, cursor control and so forth) and communication interfaces 510 (such as wireless and/or wired communication/network interface cards, modems and so forth). The elements may be coupled to each other via system bus 512, which may represent one or more buses. In the case of multiple buses, they may be bridged by one or more bus bridges (not shown).

Each of these elements may perform its conventional functions known in the art. System memory 504 and mass storage devices 506 may be employed to store a working copy and a permanent copy of the programming instructions implementing the operations associated with system 100, including determining a reboot time after a system update, referred to as computational logic 522. Computational logic 522 may be implemented by assembler instructions supported by processor(s) 502 or high-level languages (for example, C) that can be compiled into such instructions.

The number, capability and/or capacity of these elements 510-512 may vary, depending on whether computing device 500 is used as a mobile device, such as a wearable device, a smartphone, a computer tablet, a laptop and so forth, or a stationary device, such as a desktop computer, a server, a game console, a set-top box, an infotainment console, and so forth. Otherwise, the constitutions of elements 510-512 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

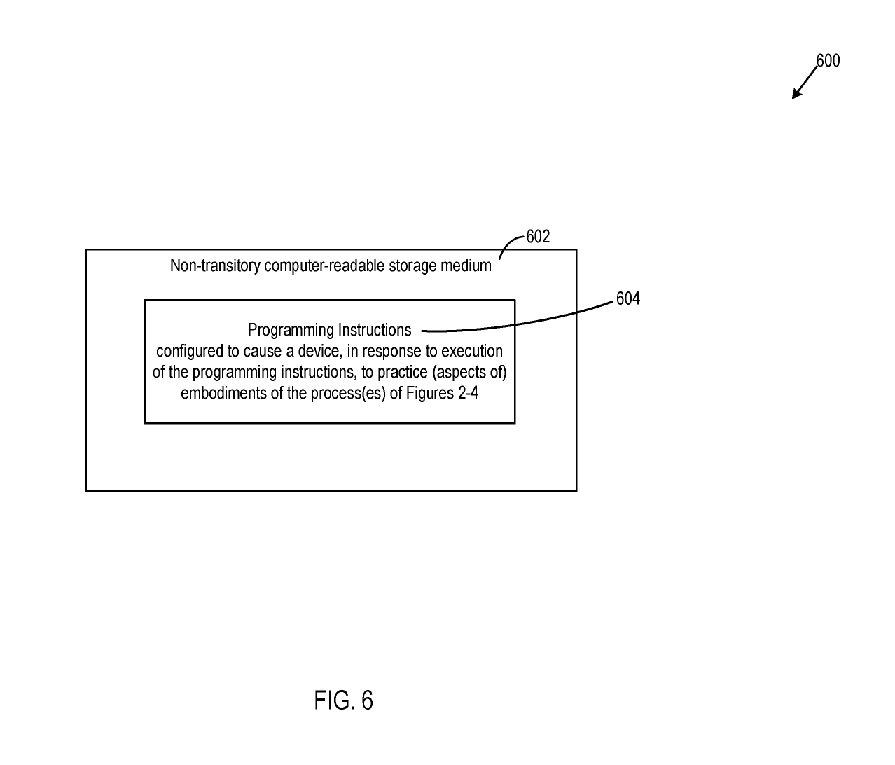

FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., computing device 500 in FIG. 5, in response to execution of the programming instructions, to implement (aspects of) system 100 in FIG. 1, as earlier described. In alternate embodiments, programming instructions 604 may be disposed on multiple computer-readable non-transitory storage media 602 instead. In still other embodiments, programming instructions 604 may be disposed on computer-readable transitory storage media 602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, transmission media such as those supporting the Internet or an intranet, or a magnetic storage device. Note that the computer-usable or computer-readable medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific to the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 5, for one embodiment, at least one of processors 502 may be packaged together with memory, as earlier described. For one embodiment, at least one of processors 502 may be packaged together with memory, to form a System in Package (SiP). For one embodiment, at least one of processors 502 may be integrated on the same die with memory. For one embodiment, at least one of processors 502 may be packaged together with memory, to form a System on Chip (SoC). For at least one embodiment, the SoC may be utilized in (but not limited to) a wearable device, a smartphone or a computing tablet.

Thus various example embodiments of the present disclosure have been described, including, but not limited to:

Example 1 is an apparatus for a reboot agent. The apparatus includes one or more electronic memory to store state data representing a state of a service running on a user equipment (UE). The apparatus includes one or more processing units designed to process a request to reboot the UE, and access the state data representing the state of the service running on the UE. The apparatus includes one or more processing units designed to generate a service activity level for the service from the state data, and compare the service activity level to an update criticality level. The apparatus includes one or more processing units designed to reschedule a determination of whether to reboot the UE if the update criticality level is less than the service activity level, and reboot the UE if the service activity level is less than the update criticality level.

Example 2 is the apparatus of Example 1, where the one or more processing units designed to reschedule the determination of whether to reboot the UE are further designed to increment the update criticality level.

Example 3 is the apparatus of Example 1, where the one or more processing units are further designed to receive the update criticality level from a software updater of the UE.

Example 4 is the apparatus of Example 1, where the one or more processing units design to generate the service activity level are further designed to generate a score vector for a variety of properties of the service, and generate the service activity level from the score vector.

Example 5 is the apparatus of Example 4, where the one or more processing units designed to reschedule the determination of whether to reboot the UE are further designed to reschedule the determination of whether to reboot the UE after a predetermined amount of time.

Example 6 is the apparatus of Example 1, where the one or more processing units designed to access the state data are further designed to collect the state data by performing operating system (OS) calls.

Example 7 is the apparatus of Example 6, where the OS calls include at least one of a cgroups call and a namespace call.

Example 8 is a computer-readable storage medium. The computer-readable storage medium has stored thereon instructions that, when implemented by a computing device, cause the computing device to update, via a software updater, a software of a user equipment (UE). The computer-readable storage medium accesses, at the software updater, state data representing a state of a service running on the UE, and generate a service activity level for the service from the state data. The computer-readable storage medium compares the service activity level to an update criticality level, and reschedules a determination of whether to reboot the UE if the update criticality level is less than the service activity level, and reboot the UE if the service activity level is less than the update criticality level.

Example 9 is the computer-readable storage medium of Example 8, where the state data includes at least one of network data, disk data, central processing unit (CPU) data, and memory allocation data.

Example 10 is the computer-readable storage medium of Example 8, where the instructions designed to access the state data further include instructions to collect the network data including data describing network traffic associated with the service.

Example 11 is the computer-readable storage medium of Example 10, where the network data identifies whether the network traffic is interactive network traffic.

Example 12 is the computer-readable storage medium of Example 10, where the network data identifies at least one of a quantity of network packets associated with the network traffic and a pattern associated with the network traffic.

Example 13 is the computer-readable storage medium of Example 8, where the instructions designed to access the state data further includes instructions to collect disk data describing an input/output (I/O) load of the service.

Example 14 is the computer-readable storage medium of Example 13, where the disk data identifies whether the service is writing data to a disk of the UE.

Example 15 is the computer-readable storage medium of Example 13, where the disk data identifies whether the service is receiving keystrokes from a keyboard.

Example 16 is the computer-readable storage medium of Example 13, where the disk data identifies a time stamp of at least one of a last write operation and a received keystroke.

Example 17 is the computer-readable storage medium of Example 8, where the instructions designed to access the state data further includes instructions to collect CPU data identifying a CPU load, of the UE, associated with the service.

Example 18 is the computer-readable storage medium of Example 8, where the instructions designed to access the state data further includes instructions to collect memory allocation data associated with a memory allocation associated with the service.

Example 19 is a method for rebooting a user equipment (UE) at a rebooting agent includes processing a request to reboot the UE, and collecting state data representing a variety of states of services running on the UE. The method also includes generating a variety of service activity levels from the state data that represent the variety of states of the services, and comparing the variety of service activity levels to an update criticality level. The method also includes rescheduling a determination of whether to reboot the UE if the update criticality level is less than at least one of the variety of service activity levels, and rebooting the UE if at least one of the variety of service activity levels is less than the update criticality level.

Example 20 is the method of Example 19, where the UE is an internet of things (IoT) UE.

Example 21 is a method. The method includes processing a request to reboot a user equipment (UE), and accessing state data representing a state of a service running on the UE. The method includes generating a service activity level for the service from the state data, and comparing the service activity level to an update criticality level. The method includes rescheduling a determination of whether to reboot the UE if the update criticality level is less than the service activity level, and rebooting the UE if the service activity level is less than the update criticality level.

Example 22 is the method of Example 21, where rescheduling the determination of whether to reboot the UE further includes incrementing the update criticality level.

Example 23 is the method of Example 21, further including receiving the update criticality level from a software updater of the UE.

Example 24 is the method of Example 21, where generating the service activity level further includes generating a score vector for a variety of properties of the service, and generating the service activity level from the score vector.

Example 25 is the method of Example 24, where rescheduling the determination of whether to reboot the UE further includes rescheduling the determination of whether to reboot the UE after a predetermined amount of time.

Example 26 is the method of Example 21, where accessing the state data further includes collecting the state data by performing operating system (OS) calls.

Example 27 is the method of Example 26, where the OS calls include at least one of a cgroups call and a namespace call.

Example 28 is a method. The method includes updating, via a software updater, a software of a user equipment (UE), and accessing, at the software updater, state data representing a state of a service running on the UE. The method includes generating a service activity level for the service from the state data, and comparing the service activity level to an update criticality level. The method includes rescheduling a determination of whether to reboot the UE if the update criticality level is less than the service activity level, and rebooting the UE if the service activity level is less than the update criticality level.

Example 29 is the method of Example 28, where the state data includes at least one of network data, disk data, central processing unit (CPU) data, and memory allocation data.

Example 30 is the method of Example 28, where accessing the state data further includes collecting the network data including data describing network traffic associated with the service.

Example 31 is the method of Example 30, where the network data identifies whether the network traffic is interactive network traffic.

Example 32 is the method of Example 30, where the network data identifies at least one of a quantity of network packets associated with the network traffic and a pattern associated with the network traffic.

Example 33 is the method of Example 28, where accessing the state data further includes collecting disk data describing an input/output (I/O) load of the service.

Example 34 is the method of Example 33, where the disk data identifies whether the service is writing data to a disk of the UE.

Example 35 is the method of Example 33, where the disk data identifies whether the service is receiving keystrokes from a keyboard.

Example 36 is the method of Example 33, where the disk data identifies a time stamp of at least one of a last write operation and a received keystroke.

Example 37 is the method of Example 28, where accessing the state data further includes collecting CPU data identifying a CPU load, of the UE, associated with the service.

Example 38 is the method of Example 28, where accessing the state data further includes collecting memory allocation data associated with a memory allocation associated with the service.

Example 39 is at least one computer-readable storage medium having stored thereon computer-readable instructions, when executed, to implement a method as exemplified in any of Examples 19-38.

Example 40 is an apparatus including a manner to perform a method as exemplified in any of Examples 19-38.

Example 41 is a manner for performing a method as exemplified in any of Examples 19-38.

It will be obvious to those having skill in the art that many changes may be made to the details of the above-described embodiments without departing from the underlying principles of the invention. The scope of the present invention should, therefore, be determined only by the following claims.

1. An apparatus for a reboot agent, comprising:
one or more electronic memory to store state data representing a state of a service running on a user equipment (UE); and
one or more processing units configured to:
process a request to reboot the UE;
access the state data representing the state of the service running on the UE;
generate a service activity level for the service from the state data;
compare the service activity level to an update criticality level;
reschedule a determination of whether to reboot the UE if the update criticality level is less than the service activity level; and
reboot the UE if the service activity level is less than the update criticality level.

2. The apparatus of claim 1, wherein the one or more processing units configured to reschedule the determination of whether to reboot the UE are further configured to increment the update criticality level.

3. The apparatus of claim 1, wherein the one or more processing units are further configured to receive the update criticality level from a software updater of the UE.

4. The apparatus of claim 1, wherein the one or more processing units configure to generate the service activity level are further configured to:
generate a score vector for a plurality of properties of the service; and
generate the service activity level from the score vector.

5. The apparatus of claim 4, wherein the one or more processing units configured to reschedule the determination of whether to reboot the UE are further configured to reschedule the determination of whether to reboot the UE after a predetermined amount of time.

6. The apparatus of claim 1, wherein the one or more processing units configured to access the state data are further configured to collect the state data by performing operating system (OS) calls.

7. The apparatus of claim 6, wherein the OS calls include at least one of a cgroups call and a namespace call.

8. A computer-readable storage medium having stored thereon instructions that, when implemented by a computing device, cause the computing device to:
update, via a software updater, a software of a user equipment (UE);
access, at the software updater, state data representing a state of a service running on the UE;
generate a service activity level for the service from the state data;
compare the service activity level to an update criticality level;
reschedule a determination of whether to reboot the UE if the update criticality level is less than the service activity level; and
reboot the UE if the service activity level is less than the update criticality level.

9. The computer-readable storage medium of claim 8, wherein the state data comprises at least one of network data, disk data, central processing unit (CPU) data, and memory allocation data.

10. The computer-readable storage medium of claim 8, wherein the instructions configured to access the state data further comprise instructions to collect the network data comprising data describing network traffic associated with the service.

11. The computer-readable storage medium of claim 10, wherein the network data identifies whether the network traffic is interactive network traffic.

12. The computer-readable storage medium of claim 10, wherein the network data identifies at least one of a quantity of network packets associated with the network traffic and a pattern associated with the network traffic.

13. The computer-readable storage medium of claim 8, wherein the instructions configured to access the state data further comprises instructions to collect disk data describing an input/output (I/O) load of the service.

14. The computer-readable storage medium of claim 13, wherein the disk data identifies whether the service is writing data to a disk of the UE.

15. The computer-readable storage medium of claim 13, wherein the disk data identifies whether the service is receiving keystrokes from a keyboard.

16. The computer-readable storage medium of claim 13, wherein the disk data identifies a time stamp of at least one of a last write operation and a received keystroke.

17. The computer-readable storage medium of claim 8, wherein the instructions configured to access the state data further comprises instructions to collect CPU data identifying a CPU load, of the UE, associated with the service.

18. The computer-readable storage medium of claim 8, wherein the instructions configured to access the state data further comprises instructions to collect memory allocation data associated with a memory allocation associated with the service.

19. A method for rebooting a user equipment (UE) at a rebooting agent, comprising:
processing a request to reboot the UE;
collecting state data representing a plurality of states of services running on the UE;
generating a plurality of service activity levels from the state data that represent the plurality of states of the services;
comparing the plurality of service activity levels to an update criticality level;
rescheduling a determination of whether to reboot the UE if the update criticality level is less than at least one of the plurality of service activity levels; and
rebooting the UE if at least one of the plurality of service activity levels is less than the update criticality level.

20. The method of claim 19, wherein the UE is an internet of things (IoT) UE.
